(19) United States
(12) Patent Application Publication
(10) Pub. No.: US 2022/0014816 A1
(43) Pub. Date: Jan. 13, 2022

(54) METHODS AND APPARATUS FOR CONFIGURING A DEVICE FOR ACCESS TO A WIRELESS NETWORK

(71) Applicant: Vestel Elektronik Sanayi ve Ticaret A.S., Manisa (TR)

(72) Inventor: Çagdas DÖNER, Manisa (TR)

(21) Appl. No.: 17/290,683

(22) PCT Filed: Nov. 2, 2018
(86) PCT No.: PCT/EP2018/080006

§ 371 Date: Apr. 30, 2021

(51) Int. Cl. H04N 21/4363; H04L 12/24; H04L 29/08; H04W 24/04; H04N 21/418

(52) U.S. Cl. CPC H04N 21/43637; H04L 41/0806; H04N 21/4183; H04W 24/04; H04L 67/34

(57) ABSTRACT

Device for access to a wireless network, the device is connected to a Personal Computer Memory Card International Association (PCMCIA) connector of a television signal receiver. Network configuration data is passed from the television signal receiver to the device via the PCMCIA connector. In some examples, the network configuration data is transmitted in a Moving Picture Experts Group (MPEG) transport stream.

### TECHNICAL FIELD

The present disclosure relates to a method and television signal receiver for configuring a device for access to a wireless network and to a method and transmitter apparatus for providing network configuration data for configuring a device for access to a wireless network.

### BACKGROUND

In order for a device to be able to connect to a wireless network and/or for configuring the connection of a device to a wireless network, it is usually necessary for the device to receive some network configuration data. In the case of some devices, a user can input the network configuration data to the device manually and directly, using for example a keyboard or other input interface which is connected to or part of the device. However, there are many devices that need to connect to a network or that need to be configured, but which do not have a user input interface such as a keyboard or the like. In any event, configuring a device for connection to a wireless network can be confusing and intimidating for many users.

### SUMMARY

According to a first aspect disclosed herein, there is provided a method of configuring a device for access to a wireless network, the method comprising:

receiving the device in a Personal Computer Memory Card International Association, PCMCIA, connector of a television signal receiver;

passing network configuration data from the television signal receiver to the device via the PCMCIA connector of the television signal receiver to configure the device for access to the wireless network.

This provides users with a simple way of providing network configuration data to a device that needs to connect to or is connected to a wireless network. This can be less intimidating for users, especially users who may not be technically skilled. This can be particularly convenient for providing network configuration data to a device that may not have a user interface or a user interface that is easy to access or use. The network configuration data may be such as to allow the device to connect to the wireless network and/or may be such as to provide some specific configuration of the wireless network connection of the device.

In an example, the method comprises receiving the network configuration data at the television signal receiver from a media operator.

In an example, the method comprises receiving the network configuration data at the television signal receiver in a Moving Picture Experts Group, MPEG, transport stream.

The MPEG transport stream may be received as a broadcast by a media operator, as in the case of for example satellite, cable or terrestrial television broadcasts. The MPEG transport stream may be received as a multicast by a media operator, as in the case of for example live IPTV (Internet Protocol television). The MPEG transport stream may be received as a unicast, as in the case of for example video-on-demand IPTV.

In an example, the method comprises receiving the network configuration data at the television signal receiver in a Conditional. Access Table of an MPEG transport stream.

In an example, the television signal receiver is connected or is connectable to the wireless network that is to be accessed by the device, the television signal receiver comprising data storage in which network configuration data that enables the television signal receiver to connect to the wireless network is stored, the television signal receiver obtaining the network configuration data required to configure the device for access to the wireless network from the network configuration data stored in the data storage.

In an example, the wireless network that is to be accessed by the device is a WiFi network and the network configuration data comprises network credentials that enable the television signal receiver and the device to connect to the WiFi network.

The network credentials for a WiFi network are typically the service set identifier (SSID) and a password. The SSID is a sequence of characters that names a wireless local area network (WLAN). The network credentials may have been input manually to the television signal receiver by a user, for example at a prior time when the user was setting up the television signal receiver to connect to the WiFi network. Alternatively or additionally, the network credentials may be provided by a media operator to the television signal receiver, for example as a broadcast or multicast or unicast as discussed above.

According to a second aspect disclosed herein, there is provided a television signal receiver, the television signal receiver comprising:

a Personal Computer Memory Card International Association, PCMCIA, connector;

the television signal receiver being arranged to pass network configuration data to a device connected in use to the PCMCIA connector for configuring the device for access to a wireless network.

In an example, the television signal receiver is arranged to receive said network configuration data in a Moving Picture Experts Group, MPEG, transport stream and to parse said transport stream to obtain said network configuration data from said transport stream.

In an example, the television signal receiver is arranged to obtain said network configuration data from a Conditional Access Table of a said MPEG transport stream.

In an example, the television signal receiver comprises data storage in which network configuration data is stored, the television signal receiver being arranged to obtain the network configuration data required to configure a said device for access to said wireless network from the network configuration data stored in the data storage.

In an example, the network configuration data comprises network credentials that enable the television signal receiver and the device to connect to a WiFi network.

According to a third aspect disclosed herein, there is provided a method of providing network configuration data for configuring a device for access to a wireless network, the method comprising:

transmitting in a Moving Picture Experts Group, MPEG, transport stream network configuration data for configuring a device for access to a wireless network such that a television signal receiver which receives the transport stream can parse the transport stream and pass the network configuration data to a device that is connected to a Personal Computer Memory Card International Association, PCMCIA, connector of the television signal receiver.

In an example, the network configuration data is transmitted in a Conditional Access Table of the MPEG transport stream.

According to a fourth aspect disclosed herein, there is provided transmitter apparatus arranged to transmit in a Moving Picture Experts Group, MPEG, transport stream network configuration data for configuring a device for access to a wireless network such that a television signal receiver which receives the transport stream can parse the transport stream and pass the network configuration data to a device that is connected to a Personal Computer Memory Card International Association, PCMCIA, connector of the television signal receiver.

In an example, the transmitter apparatus is arranged such that said network configuration data is transmitted in a Conditional Access Table of a MPEG transport stream.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of a television signal receiver to which is connected a device; and

FIG. 2 shows schematically an example of a method of of configuring a device 20 according to the present disclosure.

### DETAILED DESCRIPTION

As mentioned, in order for a device to be able to connect to a wireless network and/or for configuring the connection of a device to a wireless network, it is usually necessary for the device to receive some network configuration data. In the case of some devices, a user can input the network configuration data to the device manually and directly, using for example a keyboard or other input interface which is connected to or part of the device. However, there are many devices that need to connect to a network or that need to be configured, but which do not have a user input interface such as a keyboard or the like. In any event, configuring a device for connection to a wireless network can be confusing and intimidating for many users. This is a particular problem for devices that are intended as consumer products as consumers are often not technically minded or technically proficient.

As described herein, in examples of a method of configuring a device for access to a wireless network, the device may be located in a Personal Computer Memory Card International Association (PCMCIA) connector of a television signal receiver. Network configuration data is passed from the television signal receiver to the device via the PCMCIA connector of the television signal receiver to configure the device for access to the wireless network. This provides an arrangement for getting network configuration data into the device which is straightforward for the user and avoids the user having to locate and identify the network configuration data. It also enables the device to obtain the network configuration data in the case that the device does not have some user interface or input device such as a keyboard or the like.

The television signal receiver may be for example a television set or a set-top box or the like. The television signal receiver may be arranged to receive an MPEG (Moving Picture Experts Group) transport stream as used in for example DVB (Digital Television Broadcasting), ATSC (Advanced Television Systems Committee) and IPTV (Internet Protocol television).

The device may be for example a so-called Internet of Things (IoT) device. In general, as used herein, an IoT device is a device that has an addressable interface (e.g. an Internet protocol (IP) address, a Bluetooth identifier (ID), a near-field communication (NFC) ID, etc.) and can transmit information to one or more other devices over a wired or wireless connection. IoT devices may in general include or be incorporated in for example sensors, refrigerators, ovens, microwaves, freezers, dishwashers, clothes washing machines, clothes dryers, furnaces, air conditioners, thermostats, televisions and other consumer electronic devices, light fixtures, vacuum cleaners, sprinklers, electricity meters, gas meters, etc.

IoT devices often need to connect at least to a local network (a wireless local area network or WLAN), which may for example be a local network in a building, such as a home or an office or factory, etc. The connection may be for example a WiFi or other wireless connection. Alternatively or additionally, IoT devices may need to connect to the Internet, so as to be able to report to or receive commands or data, etc., from some remote central database or controller or the like. Such wireless connections may be via for example a cellular network (a number of examples of which will be discuss below) or a mesh or star network, including for example LPWAN (Low Power Wide Area Networks).

In general, different devices, including IoT devices in particular, have a wide range of functionality, from for example very simple sensors that might report sensed temperatures periodically through to relatively complex devices with a high degree of functionality. For simple devices in particular, there is often no user interface as such, and therefore connecting the device to a network can require relatively complicated technical steps. Even if the device has a user interface that in principle enables a user to interact directly with the device, this can still be intimidating for users who may not be technically proficient. Problems such as these are overcome or at least alleviated with examples as described herein.

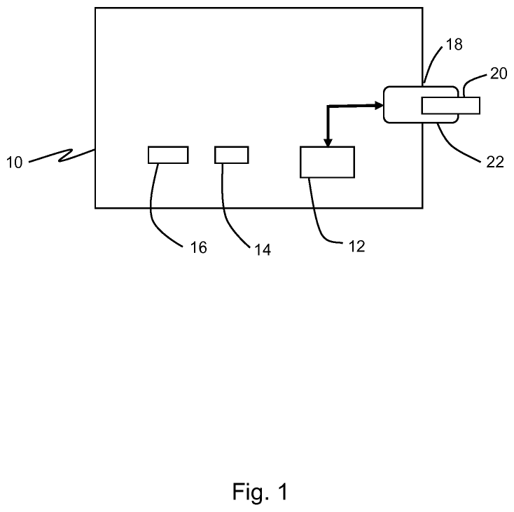

Referring now to FIG. 1, this shows schematically an example of a television signal receiver 10 to which is connected a device 20 which is to receive network configuration data via the television signal receiver 10.

In the example shown, the television signal receiver 10 is a television set which has an integral TV signal receiver or tuner. In other examples, the television signal receiver 10 may be a set-top box or the like which has a TV signal receiver or tuner and which is connected in use to a television set or other display device. The television signal receiver 10 has a processor 12, working memory 14 and data storage 16 as commonly provided in television signal receivers.

The television signal receiver 10 also has a connection or port 18 to which the device 20 can be connected to receive network configuration data via the television signal receiver 10. The port 18 is a PCMCIA (Personal Computer Memory Card International Association) connector 18.

In this regard, in DVB, the “Common Interface” (also called DVB-CI or more simply “CI”) is a technology that allows decryption of pay TV channels. In general, pay TV stations want to make their own choice as to which encryption method to use for transmission of TV channels. The Common Interface allows television set manufacturers to support many different pay TV stations, by allowing exchangeable conditional-access modules (CAM) for various encryption schemes to be plugged in. The Common Interface provides the connection between the TV tuner (in the television set or set-top box) and the CAM which decrypts the TV signal. The CAM in turn accepts the user's pay-to-view subscriber card, which contains the access keys and permissions for the user to access the pay-to-view channels. Simply put, the television set or set-top box is responsible for tuning to pay TV channels and demodulation of the received signals while the CAM is responsible for conditional access descrambling. The Common Interface is commonly provided in television signal receivers. In Europe for example, DVB-CI is obligatory in all iDTV (integrated Digital Television) television sets. The Common Interface uses the PCMCIA connector and conforms to the Common Scrambling Algorithm (CSA), the normative that specifies that such a television signal receiver must be able to accept DES (Data Encryption Standard) keys in intervals of some milliseconds and use them to decode private channels according to a specific algorithm. The Common Interface may for example be in accordance with the CI Plus Specification.

The device 20 is connected to the PCMCIA connector 18 to receive network configuration data via the television signal receiver 10. A PCMCIA connector 18 as used for a Common Interface on a television signal receiver 10 has a certain physical arrangement of connection sockets (currently two rows of 34 sockets) and feature a 16- or 32-bit interface, as well as having a certain physical size. The device 20 may be provided with a mating interface, such that the device 20 can be connected directly to the PCMCIA connector 18. Otherwise, an adapter 22 may be provided which removably receives the device 20 and provides the connection to the PCMCIA connector 18. The device 20 may for example have a USB (universal serial bus) and/or an RS-232 interface and the adapter 22 therefore likewise is provided with a USB and/or RS-232 interface to which the device 20 is connected and a PCMCIA interface to connect to the PCMCIA connector 18. Such an adapter 22 may conveniently be provided by the manufacturer of the device 20, for example as a package to be purchased together or as a separate item.

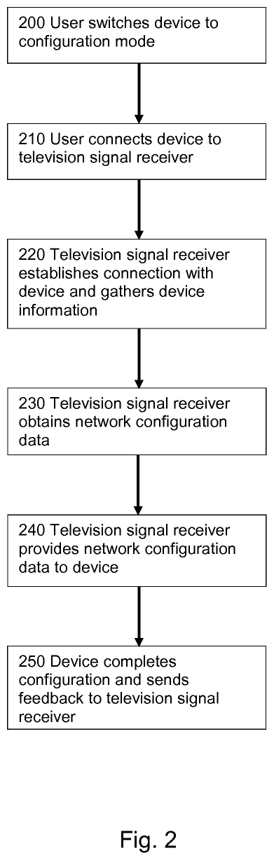

Referring to FIG. 2, this shows schematically an example of a method of configuring a device 20 according to the present disclosure. Details of a number of the stages shown schematically in FIG. 2 will be discussed further below.

At 200, the user switches the device 20 to a configuration mode, in which the device 20 is capable of being configured. This may not be necessary in all devices 20, depending on for example the set-up of the device 20. For example, some devices 20 may automatically enter a configuration mode when connected to a PCMCIA connector 18 or if the device 20 does not contain the configuration data that is necessary to allow the device 20 to connect to a wireless network.

At 210, the user connects the device 20 to the television signal receiver 10. As mentioned, this may be a direct connection between the device 20 and the PCMCIA connector 18 of the television signal receiver 10 or may be via an adapter 22.

At 220, the television signal receiver 10 detects that the device 20 has been connected and establishes the connection with the device 20 via the PCMCIA connector 18. The television signal receiver 10 may for example gather information about the device 20 that is necessary for the television signal receiver 10 to be able to provide the correct and relevant network configuration data to the device 20.

At 230, the television signal receiver 10 obtains the network configuration data that is required by the device 20. Various examples of this will be discussed below.

At 240, the television signal receiver 10 provides the network configuration data to the device 20 via the PCMCIA connector 18.

At 250, the device 20 completes the necessary network configuration. The device 20 optionally sends feedback about the configuration to the television signal receiver 10 via the PCMCIA connector 18. For example, the device 20 may inform the television signal receiver 10 that the necessary network configuration has been completed successfully. The user may then unplug the device 20 from the PCMCIA connector 18 of the television signal receiver 10.

With regard to 230, the television signal receiver 10 obtaining the network configuration data that is required by the device 20, a number of options for this are available. This depends on for example the detailed network configuration data that is required by the device 20 and how the television signal receiver 10 can obtain that data.

As a first example, the user may want the device 20 to connect to a wireless network. As a generality, the network configuration data in such a case will include network credentials such as some identifier of the network to which the device 20 will connect and some password or passphrase which is required in order for the connection to be authenticated. In the specific case that the wireless network is a WiFi network, for example, the network credentials will include an SSID (Service Set Identifier) and a password or passphrase. A service set identifier (SSID) is a sequence of characters that names a wireless local area network (WLAN) or WiFi network.

In one example of this, the television signal receiver 10 may already itself be connected to the WiFi network or at least has previously been configured (for example by the user) to connect to the WiFi network. In such a case, the television signal receiver 10 will already have stored, in for example the data storage 16, the network credentials for that WiFi network. The television signal receiver 10 can therefore read the network credentials from the data storage 16 and transmit them (possibly in some appropriate encoded form) to the device 20 when the device 20 is connected to the television signal receiver 10 at 240.

Alternatively or additionally, the television signal receiver 10 may be provided with functionality that enables the user to enter the network credentials “manually” into the television signal receiver 10, which can then again transmit them (possibly in some appropriate encoded form) to the device 20 when the device 20 is connected to the television signal receiver 10. For example, the television signal receiver 10 may have a device network configuration option which is available as a menu item or the like. The user can connect the device 20 to the PCMCIA connector 18 of the television signal receiver 10 and access the menu for the device network configuration option using for example a remote control device or directly by some input interface on the television signal receiver 10. The device network configuration option may prompt the user to enter the network credentials, again using for example a remote control device or directly, which are then transmitted to the device 20 via the PCMCIA connector 18 at 240.

Enabling the user to enter the network configuration data manually via the television signal receiver 10, for example via a menu for device network configuration, can be extended to other types of wireless network to which the device 20 is to be connected. For example, it may be desired to connect the device 20 to a “Low Power Wide Area Network” or LPWAN. The term “Low Power Wide Area Network” or LPWAN is a rather generic term, intended to convey principally that the network places low power demands on the connected devices. This makes a LPWAN particularly suitable for battery-powered devices, especially where low data transfer rates are required, which is often the case with IoT devices. LPWANs can use licensed or unlicensed frequencies and may include proprietary or open standard options. As a particular example, a LPWAN may operate on the Industrial, Scientific and Medical (ISM) spectrum at 900 MHZ, 2.4 GHz, or 5 GHz. LPWANs often have a star topology where, similarly to WiFi, each endpoint, such as devices 20, connects directly to common central access points. In such a case, the user can enter the details of the access point and any necessary password or the like manually into the television signal receiver 10, which can then pass the necessary data to the device 20.

Alternatively or additionally, the television signal receiver 10 may receive the network configuration data in some other way. As a specific example, the television signal receiver 10 may receive the network configuration data from a media operator, that is, some company or organisation which provides media (including in particular television channels) for reception by the television signal receiver 10. This can be very convenient for the user, who basically does not need to know anything about the details of the network connection.

This providing of the network configuration data by a media operator to the television signal receiver 10 may in general be used for enabling the device 20 to connect to any type of wireless network. However, it can be most appropriate in the case that the media operator is also a network provider or operator, and specifically a provider or operator of the network to which the device 20 is to connect.

As brief background, it is becoming increasingly common that media operators are also network providers or operators and vice versa. This may be because a company that historically only provided telecommunications or network services has over time moved into also providing media, such as television channels, or because a media operator has also moved into also providing telecommunications or network services.

In an example, the network configuration data may be provided to the television signal receiver 10 as part of a media transmission which is received by the television signal receiver 10. The media transmission in an example is provided by a media operator, which may also be a network operator as discussed. In this regard, the media transmission may be broadcast, that is transmitted generally for receipt by any television signal receiver 10 in coverage, as in the case of for example satellite, cable or terrestrial television broadcasts. As another example, the media transmission may be multicast, as in the case of for example live IPTV. As another example, the media transmission may be unicast, as in the case of for example video-on-demand IPTV.

In a specific example of this, the network configuration data may be transmitted in a Conditional Access Table (CAT) of an MPEG transport stream. MPEG transport streams are used in for example DVB, ATSC and IPTV media transmissions and are a standard digital container format for transmission and storage of audio, video, and Program and System Information Protocol (PSIP) data in a secure manner. Program-specific information (PSI) is metadata about a programme or channel and part of an MPEG transport stream. The PSI data as defined by ISO/IEC 13818-1 (MPEG-2 Part 1: Systems) includes four tables: PAT (Program Association Table), CAT (Conditional Access Table), PMT (Program Mapping Table) and NIT (Network Information Table). The Conditional Access Table is used for conditional access management of the cypher keys used for decryption of restricted media streams, such as pay-to-view streams. For data in the Conditional Access Table or CAT, the processed data is directed by the television signal receiver 10 to the Common Interface, conventionally to enable decryption by the conditional-access module (CAM).

In this specific example, a Conditional Access Table (CAT) or some other resource of an MPEG transport stream, or some resource such as or similar to one of the mandatory resources required by the CI Plus Specification, is used to securely carry the network configuration data required by the device 20. As noted, the media operator may also be the operator of the relevant network to which the device 20 is to connect, and therefore already has the necessary configuration data for the network. Otherwise, the media operator can obtain the necessary configuration data from the network operator (possibly under some suitable commercial arrangement). In a similar manner as occurs for pay-to-view or other subscriber services, the specific network configuration data required by the specific device 20 may be sent in the Conditional Access Table or some other resource with some customer identifier for the user. The transmission received at the television signal receiver 10 may be parsed by the television signal receiver 10 to obtain the required configuration data required for that user's specific device 20, which is then passed to the device 20 connected to the PCMCIA connector 18.

In this example where the television signal receiver 10 is obtaining the network configuration data from some source without requiring the user to enter the data manually, such as from a media operator or network operator (which may be the same organisation), the network type can in general be any of the types discussed herein, including for example cellular and non-cellular. The cellular network may be for example a 2G, 3G or 4G cellular network or, currently looking ahead, a 5G network. The cellular network may be a cellular network intended principally for IoT devices, including for example 5G, NB-IoT (Narrow Band IoT), LTE-M (Long Term Evolution for Machines). Non-cellular networks include for example WiFi and LPWAN.

In the case that the network configuration data is to enable the device 20 to connect to a wireless network, the network configuration data may include one or more of details or name of an access point for the network, possibly some password or PIN (personal identification number), and location details. The configuration data may also provide non-user specific configurations, such as reception levels and antenna power adjustments which are needed to be set for better reception. For example, in rural areas, the antenna power would be greater for better reception, but in urban areas a lower antenna power may be set which will reduce battery power consumption at the device 20.

In other examples, the network configuration data may be or include data relating to dynamic base station operations. In dynamic base station operations, it has been proposed for energy-efficient wireless communication systems (for 5G in particular) that the cellular network should dynamically shut down some base stations or adapt the base station transmissions according to the time-varying traffic load.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (e.g. a solid-state drive or SSD).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A method of configuring a device for access to a wireless network, the method comprising:
receiving the device in a Personal Computer Memory Card International Association, PCMCIA, connector of a television signal receiver;
passing network configuration data from the television signal receiver to the device via the PCMCIA connector of the television signal receiver to configure the device for access to the wireless network.

2. The method according to claim 1, comprising receiving the network configuration data at the television signal receiver from a media operator.

3. The method according to claim 1, comprising receiving the network configuration data at the television signal receiver in a Moving Picture Experts Group, MPEG, transport stream.

4. The method according to claim 3, comprising receiving the network configuration data at the television signal receiver in a Conditional Access Table of an MPEG transport stream.

5. The method according to claim 1, wherein the television signal receiver is connected or is connectable to the wireless network that is to be accessed by the device, the television signal receiver comprising data storage in which network configuration data that enables the television signal receiver to connect to the wireless network is stored, the television signal receiver obtaining the network configuration data required to configure the device for access to the wireless network from the network configuration data stored in the data storage.

6. The method according to claim 5, wherein the wireless network that is to be accessed by the device is a WiFi network and the network configuration data comprises network credentials that enable the television signal receiver and the device to connect to the WiFi network.

7. A television signal receiver, the television signal receiver comprising:
a Personal Computer Memory Card International Association, PCMCIA, connector;
the television signal receiver being arranged to pass network configuration data to a device connected in use to the PCMCIA connector for configuring the device for access to a wireless network.

8. The television signal receiver according to claim 7, arranged to receive said network configuration data in a Moving Picture Experts Group, MPEG, transport stream and to parse said transport stream to obtain said network configuration data from said transport stream.

9. The television signal receiver according to claim 8, arranged to obtain said network configuration data from a Conditional Access Table of a said MPEG transport stream.

10. The television signal receiver according to claim 7, wherein the television signal receiver comprises data storage in which network configuration data is stored, the television signal receiver being arranged to obtain the network configuration data required to configure a said device for access to said wireless network from the network configuration data stored in the data storage.

11. The television signal receiver according to claim 10, wherein the network configuration data comprises network credentials that enable the television signal receiver and the device to connect to a WiFi network.

12. The method of providing network configuration data for configuring a device for access to a wireless network, the method comprising:
transmitting in a Moving Picture Experts Group, MPEG, transport stream network configuration data for configuring a device for access to a wireless network such that a television signal receiver which receives the transport stream can parse the transport stream and pass the network configuration data to a device that is connected to a Personal Computer Memory Card International Association, PCMCIA, connector of the television signal receiver.

13. The method according to claim 12, wherein the network configuration data is transmitted in a Conditional Access Table of the MPEG transport stream.

14. Transmitter apparatus arranged to transmit in a Moving Picture Experts Group, MPEG, transport stream network configuration data for configuring a device for access to a wireless network such that a television signal receiver which receives the transport stream can parse the transport stream and pass the network configuration data to a device that is connected to a Personal Computer Memory Card International Association, PCMCIA, connector of the television signal receiver.

15. The transmitter apparatus according to claim 14, arranged such that said network configuration data is transmitted in a Conditional Access Table of a MPEG transport stream.
